(19) United States
(12) Patent Application Publication
(10) Pub. No.: US 2017/0088657 A1
(43) Pub. Date: Mar. 30, 2017

(54) NEW COPOLYMERS USEFUL IN LIQUID DETERGENT COMPOSITIONS

(71) Applicant: RHODIA OPERATIONS, Paris (FR)

(72) Inventors: Katerina KARAGIANNI, Paris (FR); Wojciech BZDUCHA, Courbevoie (FR); Suzan Hanne LIEVE BAERT, Strombeek-Bever (BE); Meng CHEN, Beijing (CN); Gang SI, Beijing (CN); Karl Ghislain BRAECKMAN, Strombeek-Bever (BE)

(21) Appl. No.: 15/126,707

(22) PCT Filed: Dec. 19, 2014
(86) PCT No.: PCT/EP2014/078840

§ 371 Date: Sep. 16, 2016

(30) Foreign Application Priority Data
Mar. 19, 2014 (CN) PCT/CN2014/073669

(51) Int. Cl. C08F 226/10; C11D 3/37; C11D 3/00

(52) U.S. Cl. CPC C08F 226/10; C11D 3/0094; C11D 3/3776

(57) ABSTRACT

The present invention relates to a copolymer useful especially as a suds boosting polymer in hand dishwashing detergent compositions. The copolymer of the invention provides improved foaming properties, and in particular may boost the suds, when added onto such hand dishwashing detergent compositions.

### FIELD OF THE INVENTION

The present invention relates to a copolymer useful especially as a suds boosting polymer in hand dishwashing detergent compositions comprising a surfactant system.

The copolymer of the invention provides improved foaming properties, and in particular may boost the suds, when added onto such hand dishwashing detergent compositions.

In particular, the suds boosting copolymers of the invention can help to reduce the level of the surfactant system without negatively impacting while even improving the suds profile of the hand dishwashing detergent composition.

The suds boosting copolymers of the invention leave also the washed items and/or the user's hands with good finish, in particular they do not leave the washed items and/or the user's hands with a greasy feel.

### BACKGROUND OF THE INVENTION

Hand dishwashing detergent compositions should have a good suds profile while providing good soil and grease cleaning and at the same time the composition should provide a pleasant washing experience, i.e, good feel on the users' hands during and after the wash and the composition should be easy to rinse. In addition, the composition should provide good finish to the washed items.

Users usually see foam as an indicator of the performance of the detergent composition. Moreover, the user of a hand dishwashing detergent composition also uses the sudsing profile and the appearance of the foam (density, whiteness) as an indicator that the wash solution still contains active detergent ingredients. The user usually doses the dishwashing detergent depending on the foam ability and renews the wash solution when the suds subsides or when the foam does not look thick enough. Thus, a dishwashing detergent composition that generates little or low density foam would tend to be replaced by the user more frequently than it is necessary. Hand dishwashing detergent compositions need to exhibit good foam height and density as well as good foam duration during the initial mixing of the detergent with water and during the entire manual dishwashing operation.

Traditionally, hand dishwashing has been done by immersing the items to be cleaned in a sink full of water. The detergent is diluted in the water. New trends seem to be moving towards the use of detergent in neat form. The detergent is either applied directly onto the item or onto a cleaning implement, such as a sponge. The properties of the detergent can be different when using it in diluted or neat form. Ideally a detergent composition should be such that it provides the best experience for both types of uses: diluted and neat form.

WO2009/037188 relates to a high foaming composition comprising a surfactant and an agent enhancing foam properties. The agent is a random copolymer comprising cationic units. The copolymers explicitly disclosed in the experimental part of this patent application do not however meet all the consumer needs in terms of suds profile and finish on the washed items and/or the user's hands after a manual dishwashing operation.

Generally, there remains a need for novel synthetic polymers, in order in particular to provide hand dishwashing detergent compositions which are more effective for certain functions and/or properties (such as exhibiting a satisfactory suds profile and at the same time a good finish on the washed items and/or the user's hands after wash) and/or which are less expensive and/or which comprise smaller amounts of active material.

In particular, there is still a need for novel synthetic polymers that can impart satisfactory (or even improved) foam properties and that at the same time provide good soil and grease removal. In addition, the hand dishwashing detergent composition comprising such a polymer should provide a pleasant experience for the user and it should not leave the cleaned items and the user's hand with a greasy feel.

### SUMMARY OF THE INVENTION

The present invention meets the above mentioned needs by providing a new copolymer comprising units derived from N,N-dimethyldiallylammonium chloride and units derived from N-vinylpyrrolidone.

According to a first aspect of the invention, there is provided a copolymer comprising:
from about 71 to about 89 mol %, preferably from about 75 to about 87 mol %, more preferably from about 78 to about 86 mol % of a hydrophilic unit derived from N-vinylpyrrolidone; and
a cationic unit derived from N,N-dimethyldiallylammonium chloride.

The copolymers of the invention provide good suds profile to hand dishwashing compositions containing them.

Advantageously, they may also impart benefits in terms of cleaning, especially tough food cleaning (cooked-, baked- and burnt-on soils) and grease cleaning. In addition, the compositions comprising a copolymer of the invention do not have the negatives that sometimes can be associated to compositions comprising alternative suds boosting polymers of the prior art, such as greasy and slippery feel during wash, in particular when the compositions are used in neat form. The greasy feel can also be left on the washed items, this can be more noticeable on plastic items.

The compositions comprising a copolymer of the invention do not provide greasy or slippery feel during wash when used either under neat or diluted form.

The compositions comprising a copolymer of the invention present also a very good rinsing profile, meaning that it is easy to get rid of the foam after washing the items.

The compositions comprising a copolymer of the invention also leave the washed items with a good finish, by good finish is herein meant that the washed items do not feel greasy or slippery either during or after rinse and the washed items feel agreeable to the touch.

In addition to the above mentioned properties, the copolymer of the invention can also provide the following additional benefits to a hand dishwashing composition:
ease of formulation of the composition,
adjustability and/or adaptability to a large number of compositions,
preservation of the transparency of the composition,
accelerated drying,
absence of or reduction in marks left on drying,
drying noticeable by the consumer, in particular by observation,
combination of at least two of these further advantages.

These additional benefits are particularly advantageous in the context of the cleaning of transparent items, especially made of glass or crystal.

All these above advantages and/or the perception of these advantages can in particular be usefully communicated, in connection with the copolymer or simply in connection with the composition, by any communication means related to the product, for example on the label, in an advertisement, via a customer service department or via an internet site.

### DEFINITIONS

“Polymer,” as used herein and as defined by F W Billmeyer, J R. in Textbook of Polymer Science, second edition, 1971, is a relatively large molecule made up of the reaction products of smaller chemical repeating units. Normally, polymers have 11 or more repeating units. Polymers may have structures that are linear, branched, star shaped, looped, hyperbranched, crosslinked, or a combination thereof. Polymers may have a single type of repeating unit or they may have more than one type of repeating unit (polymers having more than one type of repeating unit are called “copolymers”). Polymers may have the various types of repeating units arranged randomly, in sequence, in blocks, in other arrangements, or in any mixture or combination thereof. Chemicals that react with each other to form the repeating units of a polymer are known herein as “monomers” and a polymer is said herein to be made of “polymerized units” of the monomers that reacted to form the repeating units.

In the present patent application, the molar percent (mol %) of a monomer unit in a polymer (which is the amount of this monomer unit within the copolymer, expressed in mol %) can be calculated by dividing the molar amount of said monomer unit introduced in the reaction mixture during the polymerization reaction by the total molar amount of monomer units introduced in the reaction mixture during the polymerization reaction (full conversion).

In the present patent application, unless otherwise indicated, when reference is made to “molar mass”, it will relate to the absolute weight-average molar mass, expressed in g/mol. This can be determined by gel permeation chromatography (GPC), with Multi-Angle Laser Light Scattering (MALLS) detection and an aqueous eluent.

In particular, the molar mass of the copolymer of the invention may be determined by GPC, with a 0.1M NaNO₃ aqueous eluent containing 200 ppm of NaN₃ and 20 ppm (calculated as dry polymer) of a polyDADMAC polymer [available from Aldrich (product reference 409022): polydiallyldimethylammonium chloride solution in water at 20 wt %; medium molecular weight Mw=200-350 kg/mol], the measure being carried out on a sample containing about 0.5 weight % (calculated as dry polymer) of the copolymer in the above described aqueous eluent (mobile phase).

More especially, the chromatographic conditions and calculations may be the following:

A sample is diluted in the mobile phase (i.e. the above described aqueous eluent containing 200 ppm of NaN₃ and 20 ppm (calculated as dry polymer) of a polyDADMAC polymer), homogenized at least overnight and filtered through 0.45 microns Millipore filter.

Then the sample may be observed by GPC under the following conditions:
Mobile phase (eluent): 0.1M NaNO₃ water solution containing 200 ppm of NaN₃ and 20 ppm of a poly(DADMAC) polymer [available from Aldrich (product reference 409022): polydiallyldimethylammonium chloride solution in water at 20 wt %; medium molecular weight Mw=200-350 kg/mol]
Flow rate: 1 ml/min
Column: Shodex OHpak SB 806M HQ (3 columns; 30 cm)
Detection: RI (concentration detector Agilent)+MALLS (Dawn Heleos)
Sample concentration: about 0.5 weight % (calculated as dry polymer) of the copolymer in the mobile phase (eluent)
Injection volume: 100 microliter.

Then the calculation of the molar masses relies on the increment of refractive index (“dn/dc”) of the polymer.

The “dn/dc” value of a specific homo-polymer is known to a person skilled in the art, and can be found for example in POLYMER HANDBOOK. For a copolymer “dn/dc” can be calculated relatively to the weight composition of the copolymer using data available for the adequate homopolymers.

For instance, according to the present invention, the following values for the increment of refractive index “dn/dc” were used for (VP/DADMAC) copolymers:
0.1500 mL/g for (VP/DADMAC) copolymers having 70 mol % of VP units and 30 mol % of DADMAC units
0.1400 mL/g for (VP/DADMAC) copolymers having 80 mol % of VP units and 20 mol % of DADMAC units;
0.1375 mL/g for (VP/DADMAC) copolymers having 85 mol % of VP units and 15 mol % of DADMAC units;
0.1350 mL/g for (VP/DADMAC) copolymers having 90 mol % of VP units and 10 mol % of DADMAC units.

For each specific copolymer of the invention, the molar mass may be calculated based on the second order adjustment of the log (M)=f (elution volume) curve.

In the present patent application, unless otherwise mentioned, the amounts and proportions are indicated as active material (in contrast to diluted or dispersed material) and by weight.

The electrical behavior or nature (neutral, anionic or cationic) of units may depend on the pH of the environment of the copolymer, typically the pH of the composition or of a medium where the composition is used. By cationic it is meant that the unit is cationic whatever the pH, in a range of pH 3-13, preferably pH 1-14. Units comprising a quaternary ammonium group are considered as cationic.

The hydrophilic unit derived from N-vinylpyrrolidone (also named simply “vinylpyrrolidone”) is sometimes herein referred as “the hydrophilic unit”. The unit derived from N,N-dimethyldiallylammonium chloride is sometimes herein referred as “the cationic unit”.

### DETAILED DESCRIPTION OF THE INVENTION

According to a first aspect of the invention, there is provided a copolymer comprising:
from about 71 to about 89 mol % of a hydrophilic unit derived from N-vinylpyrrolidone; and
a cationic unit derived from N,N-dimethyldiallylammonium chloride.

Preferably the copolymer comprises from about 11 to about 29 mol % of the cationic unit derived from N,N-dimethyldiallylammonium chloride.

In particular, the copolymer of the invention may comprise from about 13 to about 25 mol % and especially from about 14 to about 22 mol % of the cationic unit derived from N,N-dimethyldiallylammonium chloride.

According to one embodiment, the copolymer of the invention may comprise:
from about 75 to about 87 mol % of a hydrophilic unit derived from N-vinylpyrrolidone; and
from about 13 to 25 mol % of a cationic unit derived from N,N-dimethyldiallylammonium chloride.

The copolymer of the invention is preferably a random copolymer, more preferably a linear random copolymer.

It is noted that the positive charge carried by a nitrogen atom is typically located in a side group of the macromolecular chain of which the copolymer is formed. The macromolecular chain is typically a polyethylenic chain (originating from the unsaturations of the monomers), with side cationic groups and side pyrrolidone groups.

Without being bound to theory, it is believed that the randomly distributed cationic units can bind anionic surfactants along the polymer backbone, and the complex structure can emulsify greasy soils and stabilize air in foam more effectively than block polymers which only have a partial chain length to interact with greasy soils.

According to a specific embodiment, the molar ratio of the units derived from N-vinylpyrrolidone to the units derived from N,N-dimethyldiallylammonium chloride ranges from about 77/23 (included) to about 87/13 (included), for example from 80/20 (included) to 85/15 (included).

Preferred molar ratios of the hydrophilic unit to the cationic unit are 80:20 and 85:15.

Especially preferred copolymers are those having the molar ratio of the hydrophilic unit to the cationic unit of about 80:20 and a molar mass of from about 70,000 to about 90,000 g/mol. Also preferred are polymers having the molar ratio of the hydrophilic unit to the cationic unit of about 85:15 and a molar mass of from about 85,000 to about 105,000 g/mol. Compositions comprising polymers having these unit molar ratios and molar masses are very good in terms of lack of slippery feel during the wash.

According to one embodiment, the units derived from N,N-dimethyldiallylammonium chloride and the units derived from N-vinylpyrrolidone may represent from about 90 to about 100 mol % of the units of the copolymer.

In particular, they may represent from about 95 to about 100 mol %, for example from about 97 to about 100 mol %, of the units of the copolymer.

The copolymer of the invention can comprise optional units Cₒₜₕₑᵣ which are different from the abovementioned units derived either from N,N-dimethyldiallylammonium chloride or from N-vinylpyrrolidone.

According to an advantageous embodiment, the copolymer does not comprise more than 10 mol % in total of such units; preferably, it does not comprise any at all. According to an advantageous form, the copolymer does not comprise more than 10 mol % in total of hydrophilic or hydrophobic nonionic units C_{N}; preferably, it does not comprise any at all. According to an advantageous form, the copolymer does not comprise more than 10 mol % in total of anionic or potentially anionic units C_{A}; preferably it does not contain any at all. According to an advantageous form, the copolymer does not comprise more than 10 mol % in total of cationic or potentially cationic units C_{C} which are different from the units derived from N,N-dimethyldiallylammonium chloride; preferably, it does not comprise any at all. According to an advantageous form, the copolymer does not comprise more than 10 mol % in total of zwitterionic units C_{Z}; preferably, it does not comprise any at all.

According to specific embodiments, the copolymer is substantially devoid (it comprises less than 5 mol % thereof, for example less than 2 mol % thereof, for example less than 1 mol % thereof, preferably less than 0.5 mol % thereof, preferably does not comprise any at all) of the following units:
units C_{C}, and/or
units C_{N} chosen from:
   alkoxylated units of following formula:

—CH₂—CHR⁵[—X²—(CH₂—CH₂—O)ₙ—R⁷]—
in which:
   R⁶ is a hydrogen atom or a methyl group,
   X² is a group of formula —CO—O—, —CO—NH— or —C₆H₄—CH₂—,
   N is a whole or mean number greater than or equal to 1,
   R⁷ is a hydrogen atom, an alkyl group or a tristyrylphenyl group, and/or
hydroxylated units of following formula:

—CH₂—CHR⁶[—X²—R⁸]—
in which:
   R⁶ is a hydrogen atom or a methyl group,
   X² is a group of formula —CO—O—, —CO—NH— or —C₆H₄—CH₂—,
   R⁸ is a hydrocarbon group having at least two carbon atoms which comprises at least two —OH groups, preferably on two consecutive carbon atoms, and/or
hydroxyalkyl acrylate or methacrylate units,
   hydrophobic units C_{N}, and/or
units C_{Z} comprising a sulfobetaine group, preferably all the zwitterionic units C_{Z}.

According to a specific embodiment, the copolymer of the invention is substantially devoid (it comprises less than 5 mol % thereof, for example less than 2 mol % thereof, for example less than 1 mol % thereof, preferably less than 0.5 mol % thereof, preferably does not comprise any at all) of zwitterionic units.

According to a specific embodiment, the copolymer of the invention is substantially devoid (it comprises less than 5 mol % thereof, for example less than 2 mol % thereof, for example less than 1 mol % thereof, preferably less than 0.5 mol % thereof, preferably does not comprise any at all) of anionic or potentially anionic units.

According to a specific embodiment, the copolymer of the invention is substantially devoid (it comprises less than 5 mol % thereof, for example less than 2 mol % thereof, for example less than 1 mol % thereof, preferably less than 0.5 mol % thereof, preferably does not comprise any at all) of units other than the units derived from N,N-dimethyldiallylammonium chloride and the units derived from N-vinylpyrrolidone.

It is mentioned that the copolymer of the invention can be provided in any practical form, for example in the dry solid form or in the vectorized form, for example in the form of a solution or of an emulsion or of a suspension, in particular in the form of an aqueous solution. The vectorized form, for example an aqueous solution, can in particular comprise from 5 to 70% by weight of the copolymer, for example from 10 to 60% by weight, for example from 20 to 50% by weight. The aqueous solution can in particular be a solution obtained by an aqueous-phase preparation process, in particular a radical polymerization process.

Preferably, the copolymer of the invention may have a molar mass ranging from about 10,000 to about 3,000,000 g/mol.

For instance, the copolymer of the invention may have a molar mass ranging from about 15,000 to about 2,000,000 g/mol, for example from about 20,000 to about 1,500,000 g/mol, for example from about 30,000 to about 1,000,000 g/mol, especially from about 35,000 to about 500,000 g/mol.

Polymers of these molar masses have been found very advantageous for use in detergent hand dishwashing formulations, and especially to provide very good suds profile together with a pleasant washing experience and/or a good finish to the washed items.

The following copolymers prove to be very particularly useful:
a copolymer comprising:
   from about 83 to about 87 mol %, for example about 85 mol %, of units derived from N-vinylpyrrolidone, and
   from about 13 to about 17 mol %, for example about 15 mol %, of units derived from N,N-dimethyldiallylammonium chloride,
      said copolymer having a molar mass ranging from about 75,000 to about 105,000 g/mol, for example from about 85,000 to about 105,000 g/mol, for example from about 90,000 to about 100,000 g/mol;
a copolymer comprising:
   from about 78 to about 82 mol %, for example about 80 mol %, of units derived from N-vinylpyrrolidone, and
   from about 18 to about 22 mol %, for example about 20 mol %, of units derived from N,N-dimethyldiallylammonium chloride,
      said copolymer having a molar mass ranging from about 65,000 to about 95,000 g/mol, for example from about 70,000 to about 90,000 g/mol, for example from about 75,000 to about 85,000 g/mol.

Hand dishwashing detergent compositions comprising copolymers having this specific molar ratio between the hydrophilic units and the cationic unit and further exhibiting a molar mass within this specific range were found to be also very good in terms of lack of slippery feel during the wash.

The polymer of the present invention is very effective, thus the level of polymer required to get the benefit is low. Preferably, the level of polymer is from about 0.05% to about 5%, more preferably from about 0.08% to about 2% and especially from about 0.1% to about 2% by weight of the composition.

Preferably, the surfactant system/polymer weight ratio to be found the best (in terms of finish, suds profile and/or cleaning) is from about 10:1 to about 300:1, more preferably from about 50:1 to about 200:1 and even more preferably from about 75:1 to about 150:1 and especially about 100:1.

### Process for the Preparation of the Copolymer

The copolymer of the invention can be prepared by any appropriate process. The process will generally comprise a stage of radical polymerization (copolymerization), where monomers and a source of free radicals are brought together.

According to one embodiment, a mixture of N,N-dimethyldiallylammonium chloride (DADMAC) and of N-vinylpyrrolidone (VP) is polymerized (copolymerization) in the presence of a source of free radicals, in order to obtain a copolymer comprising units deriving from VP and units deriving from DADMAC.

According to a preferred embodiment, the process comprises a stage of copolymerization by bringing together:
N,N-dimethyldiallylammonium chloride
N-vinylpyrrolidone, and
a source of free radicals.

The radical polymerization processes are known to a person skilled in the art. In particular, the source of free radicals, the amount of free radicals, the steps for introducing the various compounds (monomers, source of free radicals, and the like), the polymerization temperature and other operating parameters or conditions (like type of solvent, co-solvent, addition of non-solvent, addition of the polymer chain transfer agent or polymer chain terminating agent) can be varied in a known and appropriate way. A few details or instructions are given below.

The processes can be processes of batch type, of semibatch type or even of continuous type. A process of semibatch type typically comprises a step of gradual introduction of at least one monomer (comonomer), preferably of all the monomers (comonomers), into a reactor, without continuous departure of the reaction product, the reaction product, comprising the polymer, being recovered all at once at the end of the reaction.

It is noted that the polymerization can advantageously be carried out in aqueous solution.

Any source of free radicals can be used. It is possible in particular to generate free radicals spontaneously, for example by increasing the temperature, with appropriate monomers, such as styrene. It is possible to generate free radicals by irradiation, in particular by UV irradiation, preferably in the presence of appropriate UV-sensitive initiators. It is possible to use initiators or initiator systems of radical or redox type. The source of free radicals may or may not be water-soluble. It may be preferable to use water-soluble initiators or at least partially water-soluble initiators.

Generally, the greater the amount of free radicals, the more easily the polymerization is initiated (it is promoted) but the lower the molar masses of the copolymers obtained.

Use may in particular be made of the following initiators:
peroxides, such as: hydrogen peroxides, tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate or ammonium persulfate,
azo compounds, such as: 2,2′-azobisisobutyronitrile, 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis {2-methyl-N-[1,1-bis(hydroxymethyl)-2-hydroxyethyl]propionamide}, 2,2′-azobis[2-methyl-N-(hydroxyethyl)propionamide], 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramide), 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide] or 2,2′-azobis(isobutyramide) dihydrate,
redox systems comprising combinations, such as:
mixtures of hydrogen peroxide, alkyl peroxide, peresters, percarbonates and the like and of any iron salt, titanous salt, zinc formaldehydesulfoxylate or sodium formaldehydesulfoxylate, and reducing sugars,
alkali metal or ammonium persulfates, perborates or perchlorates, in combination with an alkali metal bisulfite, such as sodium metabisulfite, and reducing sugars, and
alkali metal persulfates in combination with an arylphosphinic acid, such as benzenephosphonic acid and others of a like nature, and reducing sugars.

The polymerization temperature can in particular be between 25° C. and 95° C. The temperature can depend on the source of free radicals. If it is not a source of UV initiator type, it will be preferable to operate between 50° C. and 95° C., more preferably between 60° C. and 80° C. Generally, the higher the temperature, the more easily the polymerization is initiated (it is promoted) but the lower the molar masses of the copolymers obtained.

### Hand Dishwashing Method

The copolymers of the invention may be particularly useful in a method of manual dishwashing comprising the step of: delivering the detergent composition as described above to a volume of water and immersing soiled dishware in the water. When such a composition is used according to this method an excellent suds profile, with a long lasting effect is achieved.

For the purpose of this invention “dishware” herein includes cookware and tableware.

The copolymers of the invention may be also very useful in a method of manual dishwashing comprising the step of: delivering the detergent composition as described above directly onto soiled dishware or onto a cleaning implement and using the cleaning implement to clean the dishware. Preferably the cleaning implement is a sponge and more preferably the sponge is wet. When such a composition is used according to this method no greasy or slippery feel is sensed by the hands of the user during and after the washing process.

In some instances, alternatives suds boosting polymers used in the prior art can give raise to a greasy and slippery feel during wash but this is not the case when a copolymer of the invention is used. It is also noted that the composition including a copolymer of the invention is very easily rinsed.

In some instances, it has been found that alternative suds boosting polymers used in the prior art can slow down the speed of rinsing, negatively impacting the user experience; however, that does not seem to be the case when using a copolymer of the invention.

### Hand Dishwashing Composition

The present invention envisages the benefits of a copolymer of the invention in a hand dishwashing detergent composition, which is preferably in liquid form. The detergent composition comprises a suds boosting polymer of the invention and a surfactant system.

In addition to imparting satisfactory (or even improved) foam properties to hand dishwashing detergent compositions and at the same time providing a pleasant experience for the user (a very good finish of the washed items is provided, the washing process is very agreeable, not exposing the user's hands to greasy feel and the washed items are left pleasant to the touch, free of strikes and with a good shine), the copolymers of the invention may also provide very good cleaning, especially grease cleaning even on plastic substrates that are the toughest substrates for grease removal. It may also be good for tough food cleaning, including cook-, baked- and burnt-on cleaning.

The detergent composition is a hand dishwashing detergent, preferably in liquid form. It typically contains from 30% to 95%, preferably from 40% to 90%, more preferably from 50% to 85% by weight of a liquid carrier in which the other essential and optional components are dissolved, dispersed or suspended. One preferred component of the liquid carrier is water.

Preferably the pH of the detergent is adjusted to between 3 and 14, more preferably between 4 and 13, more preferably between 6 and 12 and most preferably between 8 and 10. The pH of the detergent can be adjusted using pH modifying ingredients known in the art.

### Surfactant System

The surfactant system of the detergent of the invention can comprise any cleaning surfactant. Very good grease cleaning and at the same time very good suds profile have been found when the surfactant system comprises: i) an anionic surfactant; and ii) an amphoteric and/or zwitterionic surfactant. Preferably the weight ratio of anionic surfactant to amphoteric and/or zwitterionic surfactant is less than 9:1, more preferably less than 5:1, more preferably less than 4:1 and especially from about 3:1 to about 3.5:1.

Preferably the surfactant system comprises an anionic surfactant, the anionic surfactant can be any anionic cleaning surfactant, especially preferred are alkoxylated anionic surfactants, more preferably an alkyl alkoxy sulphate. Preferably the alkoxylated anionic surfactant has an average alkoxylation degree of from about 0.2 to about 3, preferably of from about 0.2 to 1. Also preferred are branched anionic surfactants having a weight average level of branching of from about 5% to about 40%.

Extremely useful surfactant systems for use herein include those comprising: anionic surfactants, in combination with amine oxide and/or betaine surfactants.

Another preferred surfactant system for use herein is an anionic and amphoteric/zwitterionic system in which the amphoteric to zwitterionic weight ratio is preferably from about 2:1 to about 1:2. In particular a system in which the amphoteric surfactant is an amine oxide surfactant and the zwitteronic surfactant is a betaine and the weight ratio of the amine oxide to the betaine is about 1:1.

Also preferred for use herein are surfactant systems comprising non-ionic surfactants. Especially preferred surfactant systems for the composition of the invention comprise an anionic surfactant preferably selected from the group consisting of alkyl sulphate, alkyl alkoxy sulphate and mixtures thereof, more preferably an alkoxylated sulfate and an amphoteric surfactant, preferably an amino oxide surfactant and a non-ionic surfactant. In summary, the most preferred surfactant system for use herein comprises an alkoxylated sulfate surfactant, amine oxide and non-ionic surfactant.

The liquid detergent can comprise from about 1% to about 50%, preferably from about 5% to about 40% more preferably from about 8% to about 35% by weight thereof of a surfactant system. The surfactant system preferably comprises an anionic surfactant, more preferably an alkoxylated sulfate anionic surfactant. The system can optionally comprise an amphoteric, zwitterionic, non-ionic surfactant and mixtures thereof.

Preferably, the surfactant system comprises alkyl sulfates and/or alkyl ethoxy sulfates; more preferably a combination of alkyl sulfates and/or alkyl ethoxy sulfates with a combined average ethoxylation degree of less than 5, preferably less than 3, more preferably less than 2 and more than 0.5 and an average level of branching of from about 5% to about 40%.

Preferably, the composition of the present invention will further comprise amphoteric and/or zwitterionic surfactant, more preferably an amine oxide and/or betaine surfactant.

The most preferred surfactant system for the detergent composition of the present invention will therefore comprise: (i) 1% to 40%, preferably 6% to 32%, more preferably 8% to 25% weight of the total composition of an anionic surfactant, preferably an alkoxylated sulfate surfactant (2) combined with 0.01% to 20% wt, preferably from 0.2% to 15% wt, more preferably from 0.5% to 10% by weight of the composition of amphoteric and/or zwitterionic and/or nonionic surfactant, more preferably an amphoteric and even more preferred an amine oxide surfactant and a non-ionic surfactant. It has been found that such surfactant system in combination with the suds boosting polymer will provide the excellent cleaning required from a hand dishwashing detergent while having very good suds profile and provides a good finish of the washed items.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C 8-C 22 alkyl, or acyl group. Such surfactants are employed in the form of water-soluble salts and the salt-forming cation usually is selected from sodium, potassium, ammonium, magnesium and mono-, di- or tri-C 2-C 3 alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included. Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the detergent of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the surfactant system comprises at least 50%, more preferably at least 60% and preferably at least 70% of branched anionic surfactant by weight of the surfactant system, more preferably the branched anionic surfactant comprises more than 50% by weight thereof of an alkyl ethoxylated sulphate having an ethoxylation degree of from about 0.2 to about 3 and preferably a level of branching of from about 5% to about 40%.

### Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial-Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.4 to about 1 and even more preferably when the anionic surfactant has a level of branching of from about 10% to about 35%, %, more preferably from about 20% to 30%.

### Sulphonate Surfactants

Suitable sulphonate surfactants for use herein include water-soluble salts of C8-C18 alkyl or hydroxyalkyl sulphonates; C11-C18 alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Nonionic surfactant, when present, is comprised in a typical amount of from 0.1% to 30%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

### Amphoteric Surfactant

Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

A preferred detergent composition comprises a suds boosting polymer of the invention and a linear C10 dimethyl amine oxide. Surprisingly, it is found that a linear C10 dimethyl amine oxide (n-decyl dimethyl amine oxide) provides a very good suds boosting effect even without the polymer of the invention.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a Cl alkyl.

### Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y— (I) wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, 0 or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃− (Ic)

R¹—CO—NH—(CH₂)₃—N⁺(CH₃)₂—CH₂CH(OH)CH₂SO₃− (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetaine.

The detergent composition herein may comprise a number of optional ingredients such as builders, chelants, conditioning polymers, cleaning polymers, surface modifying polymers, soil flocculating polymers, structurants, emmolients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic and inorganic cations such as alkaline earth metals such as Ca/Mg-ions and diamines, antibacterial agents, preservatives and pH adjusters and buffering means.

### Method of Washing

Other aspects of the invention are directed to methods of washing dishware with a composition comprising the copolymer of the present invention. Said methods comprise the step of applying the composition, preferably in liquid form, onto the dishware surface, either in diluted or neat form and rinsing or leaving the composition to dry on the surface without rinsing the surface.

By “in its neat form”, it is meant herein that said composition is applied directly onto the surface to be treated and/or onto a cleaning device or implement such as a dish cloth, a sponge or a dish brush without undergoing any dilution (immediately) prior to the application. The cleaning device or implement is preferably wet before or after the composition is delivered to it. By “diluted form”, it is meant herein that said composition is diluted by the user with an appropriate solvent, typically water. By “rinsing”, it is meant herein contacting the dishware cleaned using a process according to the present invention with substantial quantities of appropriate solvent, typically water, after the step of applying the liquid composition herein onto said dishware. By “substantial quantities”, it is meant usually about 1 to about 10 liters.

The composition herein can be applied in its diluted form. Soiled dishes are contacted with an effective amount, typically from about 0.5 ml to about 20 ml (per about 25 dishes being treated), preferably from about 3 ml to about 10 ml, of the detergent composition, preferably in liquid form, of the present invention diluted in water. The actual amount of detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from about 0.01 ml to about 150 ml, preferably from about 3 ml to about 40 ml of a liquid detergent composition of the invention is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of the present invention will comprise immersing the soiled dishes into a water bath or held under running water without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Alternatively, the device may be immersed in a mixture of the hand dishwashing composition and water prior to being contacted with the dish surface, the concentrated solution is made by diluting the hand dishwashing composition with water in a small container that can accommodate the cleaning device at weight ratios ranging from about 95:5 to about 5:95, preferably about 80:20 to about 20:80 and more preferably about 70:30 to about 30:70, respectively, of hand dishwashing liquid:water respectively depending upon the user habits and the cleaning task.

Other details or advantages of the invention may become apparent in the light of the examples which follow, without a limiting nature.

### EXAMPLES

### Example 1

### Preparation of VP/DADMAC Copolymers

The following copolymers of Vinylpyrrolidone (VP) with diallyldimethylammonium chloride (DADMAC) were synthesized in water solution in presence of 2,2′-azobis-(2-methylpropionamidine) dihydrochloride (V-50, used as a thermal radical initiator).

The syntheses were carried out at lab scale in a glass reactor equipped with mechanical stirring, an efficient heating/cooling and temperature control system, and a vapor reflux system.

The monomer mixture and V-50 water initiator solution 2 were loaded to the reactor separately in a semi-batch way during specified times and at specified temperatures (see table 1 below).

Additionally at given times the V-50 water initiator solutions 1, 3, 4 and 5 were loaded to the reactor as shot additions. The nitrogen sparge to the reaction mixture was used during all the synthesis.

The general synthesis procedure is the following:
1. Set up the initiator and monomer feed vessels on the balances and prime the charge lines.
2. Load demineralized water to reactor.
3. Begin agitation at 150 RPM.
4. Begin a nitrogen sparge. Maintain the sparge throughout the reaction.
5. Heat the reactor to 75° C. (or 80° C.—see table 1 below).
6. Load the initiator solution 1 charge to the reactor as a shot addition.
7. Begin a co-feed of the semi-batch initiator solution 2 with the semi-batch monomer solution.
   a. Feed appropriate quantities of the initiator solution 2 over appropriate time (see table 1 below).
   b. Starting at the same time, feed appropriate quantities of the monomers solution mixture over appropriate time (see table 1 below).
8. After the end of the initiator solution 2 feed, keep heating at 75° C. (or 80° C.—see table 1 below) during 1 hour
9. Heat the reactor to 85° C. during 15 minutes
10. Load the initiator solution 3 charge to the reactor as a shot addition
11. Keep heating at 85° C. during 2 hour
12. Load the initiator solution 4 charge to the reactor as a shot addition
13. Keep heating at 85° C. during 2 hour
14. Load the initiator solution 5 charge to the reactor as a shot addition
15. Keep heating at 85° C. during 2 hour
16. Cool the product to <40° C. and discharge the product (in the form of a liquid solution in water)

According to this procedure several copolymers were synthesized, with different monomer (VP/DADMAC) molar ratios (varying from 70/30 to 90/10) and similar copolymer average molar masses (Mw around 90 kg/mol).

The particular charges of the reagents and reaction conditions (monomers mixture and initiator solution 2 semi-batch feed durations, reaction temperature during semi-batch reagents feeds) are given in the table 1 below.

TABLE 1
Reagents charges and reaction conditions for particular copolymers synthesis.

| | | | | | Monomers mixture load | | | |
|---|---|---|---|---|---|---|---|---|
| | | | | | | | DADMAC | |
| | | | Initiator | | | | at 65% | |
| | Molar ratio | Water | solution 1 load | | | | water | feed |
| Example | (VP/DADMAC) | load, | V-50, | Water, | Water, | VP, | solution, | duration, |
| reference | % mol | grams | grams | grams | grams | grams | grams | minutes |
| Copolymer 1 | 90/10 | 310.0 | 1.25 | 5.9 | 91.3 | 430.2 | 107.3 | 180 |
| Copolymer 2 | 85/15 | 580.0 | 0.39 | 1.84 | 40.7 | 258.4 | 102.4 | 180 |
| Copolymer 3 | 80/20 | 310.0 | 1.25 | 5.9 | 57.7 | 366.3 | 205.6 | 180 |
| Copolymer 4 | 70/30 | 320.0 | 0.08 | 2.0 | 105.4 | 105.4 | 101.1 | 180 |

| | | | | Reaction | Initiator | |
|---|---|---|---|---|---|---|
| | | | | T° C. during | solutions | |
| | Initiator solution 2 load | | | Monomers | 3, 4 and 5 [symbol] | |
| | | | feed | and Initiator | loads | |
| Example | V-50, | water, | duration, | solution 2 | V-50, | wat [symbol] |
| reference | grams | grams | minutes | feeds | grams | gra [symbol] |
| Copolymer 1 | 11.2 | 53.0 | 240 | 75 | 1.25 | 5. [symbol] |
| Copolymer 2 | 2.6 | 25.2 | 240 | 75 | 0.81 | 3. [symbol] |
| Copolymer 3 | 9.85 | 46.5 | 240 | 75 | 1.25 | 5. [symbol] |
| Copolymer 4 | 0.62 | 30.2 | 240 | 80 | 0.77 | 5. [symbol] |

[symbol]

indicates data missing or illegible when filed

The molar masses of these copolymers were determined according to the protocol detailed in the specification, namely by GPC, with a 0.1M NaNO₃ aqueous eluent containing 200 ppm of NaN₃ and 20 ppm (calculated as dry polymer) of a polyDADMAC polymer [available from Aldrich (product reference 409022): polydiallyldimethylammonium chloride solution in water at 20 weight %; medium molecular weight Mw=200-350 kg/mol], the measure being carried out on a sample containing about 0.5 weight % (calculated as dry polymer) of the copolymer in the above described aqueous eluent.

More especially, the chromatographic conditions and calculations were the following:

A sample is diluted in the mobile phase (=the above described aqueous eluent containing 200 ppm of NaN₃ and 20 ppm (calculated as dry polymer) of a polyDADMAC polymer), homogenized at least overnight and filtered through 0.45 microns Millipore filter.

Then the sample is observed by GPC under the following conditions:
Mobile phase (eluent): 0.1M NaNO₃ water solution containing 200 ppm of NaN₃ and 20 ppm of a polyDADMAC polymer [available from Aldrich (product reference 409022): polydiallyldimethylammonium chloride solution in water at 20 weight %; medium molecular weight Mw=200-350 kg/mol],
Flow rate: 1 ml/min
Column: Shodex OHpak SB 806M HQ (3 columns; 30 cm)
Detection: RI (concentration detector Agilent)+MALLS (Dawn Heleos)
Sample concentration: about 0.5 weight % (calculated as dry polymer) of the copolymer in the mobile phase (eluent)
Injection volume: 100 microliter.

The following values for the increment of refractive index “dn/dc” were used for (VP/DADMAC) copolymers:
0.1500 mL/g for (VP/DADMAC) copolymers having 70 mol % of VP units and 30 mol % of DADMAC units
0.1400 mL/g for (VP/DADMAC) copolymers having 80 mol % of VP units and 20 mol % of DADMAC units;
0.1375 mL/g for (VP/DADMAC) copolymers having 85 mol % of VP units and 15 mol % of DADMAC units;
0.1350 mL/g for (VP/DADMAC) copolymers having 90 mol % of VP units and 10 mol % of DADMAC units.

For each specific copolymer, the molar mass has been calculated based on the second order adjustment of the log (M)=f (elution volume) curve.

The results were the following:

| | VP molar %/ | Mw |
|---|---|---|
| Example reference | DADMAC molar % | (kg/mol) |
| Copolymer 1 | 90/10 | 95 |
| Copolymer 2 | 85/15 | 95 |
| Copolymer 3 | 80/20 | 80 |
| Copolymer 4 | 70/30 | 101 |

### Example 2

### Evaluation of the Suds Performance in Hand Dish Detergent Compositions

The suds performance of hand dishwashing detergent compositions (Examples A-E) was assessed according to the method described herein below.

Example A, containing no polymer, was used as a reference.

Examples B and E, outside the scope of the invention, were used as comparative examples.

| | A | | | | |
|---|---|---|---|---|---|
| Product (wt %) | (Ref) | B | C | D | E |
| Alkyl C₁₀₋₁₄ Ethoxy | 20.15 | 20.15 | 20.15 | 20.15 | 20.15 |
| Sulphate (AE0.6S) | | | | | |
| C12-14 dimethyl | 5.45 | 5.45 | 5.45 | 5.45 | 5.45 |
| amine oxide | | | | | |
| Branched Nonionic: | 0.40 | 0.40 | 0.40 | 0.40 | 0.40 |
| 3-propyl heptanol | | | | | |
| EO8 | | | | | |
| PEI600-EO10-PO7 | 0.3 | 0.3 | 0.3 | 0.3 | 0.3 |
| block polymer | | | | | |
| Ethanol | 2.5 | 2.5 | 2.5 | 2.5 | 2.5 |
| Polypropylene | 0.4 | 0.4 | 0.4 | 0.4 | 0.4 |
| glycol MW2000 | | | | | |
| Sodium Chloride | 1.0 | 1.0 | 1.0 | 1.0 | 1.0 |
| Poly-(VP-co- | | | | | |
| DADMAC) polymer | | | | | |
| Copolymer 4 | — | 0.3 | — | — | — |
| (VP/DADMAC | | | | | |
| 70:30, MW 101k | | | | | |
| g/mol) | | | | | |
| Copolymer 3 | — | — | 0.3 | — | — |
| (VP/DADMAC | | | | | |
| 80:20, Mw 80k | | | | | |
| g/mol) | | | | | |
| Copolymer 2 | — | — | — | 0.3 | — |
| (VP/DADMAC | | | | | |
| 85:15, Mw 95k | | | | | |
| g/mol) | | | | | |
| Copolymer 1 | — | — | — | — | 0.3 |
| (VP/DADMAC | | | | | |
| 90:10, Mw 95k | | | | | |
| g/mol) | | | | | |
| Minors* and water | to balance up to 100% | | | | |
| Performance: | | | | | |
| | REF | Compar- | | | Compar- |
| | | ative | | | ative |
| Suds mileage index | 100 | 106 | 118 | 117 | 111 |

*Minors include perfume, dyes, preservatives
VP: vinylpyrrolidone
DADMAC: N,N-dimethyldiallylammonium chloride

The compositions comprising suds boosting polymers according to the invention (C and D) presented a significantly better suds mileage than the reference (A) and presented better suds mileage than compositions comprising a similar polymer outside the scope of the invention (B and E).

This method measures the suds profile of a product versus a reference. The suds profile of the detergent composition herein can be measured by employing a suds cylinder tester (SCT). The SCT has a set of 8 cylinders.

Each cylinder is typically 30 cm long and 9 cm in diameter and may be independently rotated at a rate of 20-22 revolutions per minute (rpm).

For executing the test, 8 cylinders are used when comparing 7 or less test products versus a reference.

When not all cylinders contain a test product, the empty cylinder(s) should always be filled with the same amount of water as the other cylinders to maintain the right balance.

Composition of the Artificial Soil (Available from J&R Coordinating (Cincinnati, Ohio, USA)

| Ingredient | Wt (%) |
|---|---|
| Oleic acid | 0.14 |
| Crisco oil | 12.73 |
| Crisco shortening | 27.75 |
| Lard | 7.64 |
| Refined Beef Tallow | 51.68 |
| Palmitic acid | 0.04 |
| Stearic acid | 0.02 |
| Total | 100 |

### Test Procedure

1. A water solution of a detergent composition to be tested is prepared by dissolving 0.6 g+/−0.01 g detergent composition into 500 ml water having water hardness of 15 dH and temperature of 41° C.
2. The water solution in the cylinder has a height which is deemed to be a constant during the whole test.
3. A scale is stuck on the external wall of each cylinder with 0 starting from the top surface of the cylinder bottom.
4. The SCT rotates at 22 rpm for a time period as specified below, then stop rotation and read the suds height which is the number of the top layer of suds minus the water solution height.
5. The height of the top layer of suds should be the line which crosses the interface of air and dense suds and is vertical to the cylinder wall.
6. Scattered bubbles clinging to the interior surface of the cylinder wall shall not be counted in reading the suds height.
7. The SCT first rotates at 22 rpm for 2 minutes.
8. Stop rotation and add 1 ml of artificial soil to each cylinder.
9. Start the SCT to rotate at 22 rpm for 1 minute.
10. After 1 minute, stop rotation and read the suds height.
11. Repeat steps 9 and 10 until suds height in each cylinder reaches 0.5 cm.
12. Repeat steps 1 to 11 with the product order reversed in the cylinders to remove bias between replicates.

### Sample Result (for Illustration Purposes)

| | Run 1 | | | | Run 2 | | | |
|---|---|---|---|---|---|---|---|---|
| Additions | 1 | 2 | 3 | 4 | 4 | 3 | 2 | 1 |
| 0 | 7.5 | 7.8 | 7.9 | 7.4 | 8.0 | 7.7 | 8.0 | 7.2 |
| 1 | 6.7 | 7.7 | 7.4 | 7.2 | 7.3 | 7.4 | 8.0 | 6.5 |
| 2 | 5.7 | 7.3 | 6.9 | 5.4 | 5.0 | 6.7 | 7.2 | 5.5 |
| 3 | 3.5 | 6.2 | 5.3 | 3.6 | 3.6 | 5.0 | 6.0 | 3.5 |
| 4 | 1.5 | 4.5 | 3.8 | 1.7 | 1.6 | 3.5 | 4.4 | 1.5 |
| 5 | 0.9 | 0.8 | 0.7 | 0.5 | 1.0 | 1.4 | 2.2 | 0.7 |
| 6 | 0.4 | 0.8 | 0.7 | | 0.5 | 0.6 | 0.7 | 0.3 |
| 7 | | 0.6 | 0.5 | | | 0.4 | 0.5 | |
| 8 | | 0.3 | | | | | | |
| Total suds | 26.2 | 36.0 | 33.2 | 25.8 | 27.0 | 32.7 | 37.0 | 25.2 |
| Mileage | 5.8 | 7.3 | 7 | 5 | 6.0 | 6.5 | 7.0 | 5.5 |
| % Suds | 100 | 137 | 127 | 98 | 107 | 130 | 147 | 100 |
| % Mileage | 100 | 126 | 121 | 86 | 109 | 118 | 127 | 100 |

### Example 3

### Evaluation of the Greasy Feel on Items and Hands During and after Manual Dishwashing

The greasy feel on items and on the user's hands during and after manual dishwashing of the reference and Examples 1-4 was assessed according to the method described herein below.

| | REF | 1 | 2 | 3 | 4 |
|---|---|---|---|---|---|
| Product (wt %) | | | | | |
| Alkyl C₁₀₋₁₄ Ethoxy | 20.15 | 20.15 | 20.15 | 20.15 | 20.15 |
| Sulphate (AE0.6S) | | | | | |
| C12-14 dimethyl | 5.45 | 5.45 | 5.45 | 5.45 | 5.45 |
| amine oxide | | | | | |
| Branched Nonionic: 3- | 0.40 | 0.40 | 0.40 | 0.40 | 0.40 |
| propyl heptanol EO8 | | | | | |
| PEI600-EO10-PO7 | 0.3 | 0.3 | 0.3 | 0.3 | 0.3 |
| block polymer | | | | | |
| Ethanol | 2.5 | 2.5 | 2.5 | 2.5 | 2.5 |
| Polypropylene glycol | 0.4 | 0.4 | 0.4 | 0.4 | 0.4 |
| MW2000 | | | | | |
| Sodium Chloride | 1.0 | 1.0 | 1.0 | 1.0 | 1.0 |
| Poly-(VP-co- | | | | | |
| DADMAC) polymer | | | | | |
| Copolymer 4 | — | 0.3 | — | — | — |
| (VP/DADMAC | | | | | |
| 70:30, Mw 101k | | | | | |
| g/mol) | | | | | |
| Copolymer 3 | — | — | 0.3 | — | — |
| (VP/DADMAC | | | | | |
| 80:20, Mw 80k | | | | | |
| g/mol) | | | | | |
| Copolymer 2 | — | — | — | 0.3 | — |
| (VP/DADMAC | | | | | |
| 85:15, Mw 95k | | | | | |
| g/mol) | | | | | |
| Copolymer 1 | — | — | — | — | 0.3 |
| (VP/DADMAC | | | | | |
| 90:10, Mw 95k | | | | | |
| g/mol) | | | | | |
| Minors* and water | to balance up to 100% | | | | |
| Performance: | | | | | |
| | REFER- | Compar- | | | Compar- |
| | ENCE | ative | | | ative |
| Greasy feel on items | Interme- | Yes | No | No | Interme- |
| | diate | | | | diate |
| Greasy feel on hands | Yes | Yes | No | No | Yes |

Compositions of Examples 2 and 3 (according to the invention) gives better performances than the reference, both in terms of greasy feel on items and greasy feel on hands after wash. Contrary to the reference, Compositions of Examples 2 and 3 do not present greasy feel during or after wash either on the washed items or on hands.

Compositions 1 and 4 (outside the scope of the invention) present on the contrary inacceptable greasy feel during and after wash on the washed items and on hands.

In addition, the composition of Example 2 does not present slippery feel and it has a very good rinsing profile, in particular when glass items are washed.

### Greasy Feel Evaluation Test Method

The greasy feel on items and hands during and after wash is evaluated by three different panelists by placing 0.5 ml of the test product on a sponge to wash a plastic container (available from IKEA under reference PRUTA 1.5 L) which has been soiled with a table spoon of sunflower oil. The wash is done using soft water (2 dH).

### Example 4

### Examples of Formulations

Other examples of formulations with suds boosting polymer: 5 to 11

| | 5 | 6 | 7 | 8 | 9 | 10 | 11 |
|---|---|---|---|---|---|---|---|
| Alkyl C₁₀₋₁₄ Ethoxy Sulphate | 26.9 | — | — | 25.7 | — | 11.1 | 21.0 |
| (AE0.6S) | | | | | | | |
| Alkyl C₁₀₋₁₄ Ethoxy Sulphate (AE2S) | — | 18.7 | 26.9 | — | 18.7 | — | — |
| Sodium alkyl benzene sulfonate | — | 8.0 | — | — | — | — | — |
| Sodium paraffin sulfonate | — | — | — | — | 8.0 | — | — |
| C12-14 dimethyl amine oxide | 6.1 | — | — | 4.1 | — | 3.7 | 10.0 |
| Cocamido propyl betaine | — | 4.5 | 6.8 | 3.2 | 6.0 | — | — |
| C12-13 EO7 nonionic | — | — | — | — | — | 1.0 | 2.0 |
| Branched Nonionic: 3-propyl | 1.0 | 0.8 | — | — | — | — | 1.0 |
| heptanol EO8 | | | | | | | |
| PEI600-EO10-PO7 block | — | — | 0.8 | — | — | 0.4 | 0.8 |
| polymer | | | | | | | |
| Ethanol | 4.0 | 5.0 | 3.0 | 3.0 | 2.0 | — | 3.0 |
| Polypropylene glycol MW2000 | 1.1 | 0.8 | 1.1 | 1.1 | 1.1 | 0.5 | 1.1 |
| Sodium Chloride | 1.3 | 0.8 | 1.3 | 0.5 | 0.8 | 1.3 | 1.3 |
| Copolymer 3 (VP/DADMAC | 0.5 | 0.4 | 0.3 | 0.3 | 0.3 | 0.2 | 0.5 |
| 80:20, Mw 80 k g/mol) | | | | | | | |

| | |
|---|---|
| Minors* and water | to balance up to 100% |

### Example 5

### Preparation of other VP/DADMAC 80 mol %/20 mol % Copolymers

The following copolymers of Vinylpyrrolidone (VP) with diallyldimethylammonium chloride (DADMAC) were synthesized in water solution in presence of 2,2′-azobis-(2-methylpropionamidine) dihydrochloride (V-50, used as a thermal radical initiator). The general synthesis procedure was as described in Example 1.

The particular charges of the reagents and reaction conditions (monomers mixture and initiator solution 2 semi-batch feed durations, reaction temperature during semi-batch reagents feeds) are given in the table 2 below.

TABLE 2
Reagents charges and reaction conditions for particular copolymers synthesis.

| | | | | | Monomers mixture load | | | |
|---|---|---|---|---|---|---|---|---|
| | | | | | | | DADMAC | |
| | | | Initiator | | | | at 65% | |
| | Molar ratio | Water | solution 1 load | | | | water | feed |
| Example | (VP/DADMAC) | load, | V-50, | Water, | Water, | VP, | solution, | duration, |
| reference | % mol | grams | grams | grams | grams | grams | grams | minutes |
| Copolymer 5 | 80/20 | 382.5 | 0 | 0 | 69.9 | 329.7 | 120.3 | 180 |
| Copolymer 6 | 80/20 | 511.1 | 0.36 | 1.32 | 340.4 | 340.4 | 191.3 | 180 |
| Copolymer 7 | 80/20 | 440.0 | 1.00 | 5.9 | 46.1 | 293.1 | 164.5 | 120 |
| Copolymer 8 | 80/20 | 567.0 | 0.79 | 3.8 | 49 | 230.8 | 129.6 | 120 |

| | | | | Reaction | Initiator | |
|---|---|---|---|---|---|---|
| | | | | T° C. during | solutions | |
| | Initiator solution 2 load | | | Monomers | 3, 4 and 5 [symbol] | |
| | | | feed | and Initiator | loads | |
| Example | V-50, | water, | duration, | solution 2 | V-50, | wat [symbol] |
| reference | grams | grams | minutes | feeds | grams | gra [symbol] |
| Copolymer 5 | 2.7 | 24.3 | 240 | 75 | 1.12 | 5. [symbol] |
| Copolymer 6 | 3.72 | 91.1 | 240 | 75 | 1.16 | 12. [symbol] |
| Copolymer 7 | 7.0 | 32.9 | 180 | 75 | 1.0 | 4. [symbol] |
| Copolymer 8 | 5.5 | 26.9 | 180 | 75 | 0.79 | 3. [symbol] |

[symbol]

indicates data missing or illegible when filed

The molar masses of these copolymers were determined according to the protocol detailed in Example 1.

The results were the following:

| | VP molar %/ | Mw |
|---|---|---|
| Example reference | DADMAC molar % | (kg/mol) |
| Copolymer 5 | 80/20 | 235 |
| Copolymer 6 | 80/20 | 146 |
| Copolymer 7 | 80/20 | 70 |
| Copolymer 8 | 80/20 | 53 |

The suds performance of hand dishwashing detergent compositions comprising these copolymers of the invention was assessed according to the method described in Example 2. The detergent formulations were identical to those described in Example 2, except for the VP/DADMAC copolymer which was replaced by one of the Copolymers 5-8.

All the compositions comprising suds boosting polymers according to the invention presented significantly better suds mileage than the reference.

The greasy feel on items and hands after manual dishwashing was also assessed according to the method described in Example 3.

The detergent formulations were identical to those described in Example 3, except for the VP/DADMAC copolymer which was replaced by one of the Copolymers 5-8.

All the compositions comprising suds boosting polymers according to the invention presented an improved greasy feel (on washed items and/or on hands) compared to the reference.

### Example 6

### Preparation of other VP/DADMAC 85 mol %/15 mol % Copolymers

The following copolymers of Vinylpyrrolidone (VP) with diallyldimethylammonium chloride (DADMAC) were synthesized in water solution in presence of 2,2′-azobis-(2-methylpropionamidine) dihydrochloride (V-50, used as a thermal radical initiator). The general synthesis procedure was as described in Example 1.

The particular charges of the reagents and reaction conditions (monomers mixture and initiator solution 2 semi-batch feed durations, reaction temperature during semi-batch reagents feeds) are given in the table 3 below.

TABLE 3
Reagents charges and reaction conditions for particular copolymers synthesis.

| | | | | | Monomers mixture load | | | |
|---|---|---|---|---|---|---|---|---|
| | | | | | | | DADMAC | |
| | | | Initiator | | | | at 65% | |
| | Molar ratio | Water | solution 1 load | | | | water | feed |
| Example | (VP/DADMAC) | load, | V-50, | Water, | Water, | VP, | solution, | duration, |
| reference | % mol | grams | grams | grams | grams | grams | grams | minutes |
| Copolymer 9 | 85/15 | 580.0 | 0.16 | 0.77 | 40.7 | 258.4 | 102.4 | 180 |
| Copolymer | 85/15 | 580.0 | 0.81 | 3.8 | 40.7 | 258.4 | 102.4 | 180 |
| 10 | | | | | | | | |

| | | | | Reaction | Initiator | |
|---|---|---|---|---|---|---|
| | | | | T° C. during | solutions | |
| | Initiator solution 2 load | | | Monomers | 3, 4 and 5 [symbol] | |
| | | | feed | and Initiator | loads | |
| Example | V-50, | water, | duration, | solution 2 | V-50, | wat [symbol] |
| reference | grams | grams | minutes | feeds | grams | gra [symbol] |
| Copolymer 9 | 1.63 | 15.8 | 240 | 75 | 0.81 | 3. [symbol] |
| Copolymer | 6.4 | 62.2 | 240 | 75 | 0.81 | 3. [symbol] |
| 10 | | | | | | |

[symbol]

indicates data missing or illegible when filed

The molar masses of these copolymers were determined according to the protocol detailed in Example 1.

The results were the following:

| | VP molar %/ | Mw |
|---|---|---|
| Example reference | DADMAC molar % | (kg/mol) |
| Copolymer 9 | 85/15 | 152 |
| Copolymer 10 | 85/15 | 42 |

The suds performance of hand dishwashing detergent compositions comprising these copolymers of the invention was assessed according to the method described in Example 2. The detergent formulations were identical to those described in Example 2, except for the VP/DADMAC copolymer which was replaced by one of the Copolymers 9 or 10.

All the compositions comprising suds boosting polymers according to the invention presented significantly better suds mileage than the reference.

The greasy feel on items and hands after manual dishwashing was also assessed according to the method described in Example 3.

The detergent formulations were identical to those described in Example 3, except for the VP/DADMAC copolymer which was replaced by one of the Copolymers 9 or 10.

All the compositions comprising suds boosting polymers according to the invention presented an improved greasy feel (on washed items and/or on hands) compared to the reference.

1-11. (canceled)

12. A copolymer comprising:
from about 71 to about 89 mol % of a hydrophilic unit derived from N-vinylpyrrolidone; and
a cationic unit derived from N,N-dimethyldiallylammonium chloride.

13. The copolymer according to claim 12 comprising from about 11 to about 29 mol % of the cationic unit derived from N,N-dimethyldiallylammonium chloride.

14. The copolymer according to claim 12 comprising:
from about 75 to about 87 mol % of the hydrophilic unit derived from N-vinylpyrrolidone; and
from about 13 to 25 mol % of the cationic unit derived from N,N-dimethyldiallylammonium chloride.

15. The copolymer as claimed in claim 12, wherein the copolymer is a linear random copolymer.

16. The copolymer as claimed in claim 12, wherein the units derived from N,N-dimethyldiallylammonium chloride and the units derived from N-vinylpyrrolidone represent from about 90 to about 100 mol % of the units of the copolymer.

17. The copolymer as claimed in claim 12, wherein the copolymer is substantially devoid of zwitterionic units.

18. The copolymer as claimed in claim 12, wherein the copolymer is substantially devoid of anionic or potentially anionic units.

19. The copolymer as claimed in claim 12, wherein the copolymer has a molar mass ranging from about 10,000 to about 3,000,000 g/mol.

20. The copolymer as claimed in claim 12, wherein the copolymer has a molar mass ranging from about 35,000 to about 500,000 g/mol.

21. The copolymer as claimed in claim 12, comprising:
from about 78 to about 82 mol % of units derived from N-vinylpyrrolidone; and
from about 18 to about 22 mol % of units derived from N,N-dimethyldiallylammonium chloride,
wherein the copolymer has a molar mass ranging from about 65,000 to about 95,000 g/mol.

22. The copolymer as claimed in claim 12, comprising:
from about 83 to about 87 mol % of units derived from N-vinylpyrrolidone; and
from about 13 to about 17 mol % of units derived from N,N-dimethyldiallylammonium chloride,
wherein the copolymer has a molar mass ranging from about 85,000 to about 105,000 g/mol.

23. The copolymer as claimed in claim 12, wherein the units derived from N,N-dimethyldiallylammonium chloride and the units derived from N-vinylpyrrolidone represent from about 95 to about 100 mol % of the units of the copolymer.

24. The copolymer as claimed in claim 12, wherein the copolymer has a molar mass ranging from about 20,000 to about 1,500,000 g/mol.

25. The copolymer as claimed in claim 21, wherein the copolymer has a molar mass ranging from about 70,000 to about 90,000 g/mol.

26. The copolymer as claimed in claim 22, wherein the copolymer has a molar mass ranging from about 90,000 to about 100,000 g/mol.
